(19) United States
(12) Patent Application Publication
(10) Pub. No.: US 2002/0014827 A1
(43) Pub. Date: Feb. 7, 2002

(54) Electron gun for cathode ray tube

(76) Inventor: Sung-Jun An, Yangsan-city (KR)

Correspondence Address: CHRISTIE, PARKER & HALE, LLP, 350 WEST COLORADO BOULEVARD, SUITE 500, PASADENA, CA, 91105, US

(21) Appl. No.: 09/916,901

(22) Filed: Jul. 26, 2001

(30) Foreign Application Priority Data
Jul. 27, 2000 (KR) 2000-43277

(51) Int. Cl. H01J 29/46

(52) U.S. Cl. 313/446

(57) ABSTRACT

An electron gun for a cathode ray tube. The electron gun has a plurality of cathodes, a plurality of grids arranged at one side of the cathode and having electron beam-passing holes through which electrons emitted from the cathode pass, and a shield cup connected with a final grid and having electron beam-passing holes. The cathode including a cylindrical sleeve, a base metal supported by the sleeve and having a concave surface applied with electron emitting materials with a uniform radius of a curvature from a central point in the electron beam-passing hole of a first grid which is in the closest vicinity of the cathode, wherein the central point is located flush with a surface of the first grid toward the cathode, and a heater installed in the inside of the sleeve for heating the base metal. The density of focused electrons may be increased without increasing the current density even though the diameter of the electron beam-passing hole of the first grid is reduced, making it possible to improve the electron focusing ratio of the first grid while preventing decrease in the lifespan, thereby improving the resolution of the cathode ray tube.

### CROSSREFERENCE TO RELATED APPLICATION

This application claims priority of application No. 2000-43277 filed with the Korea Patent Office on Jul. 27, 2000, the content of which is incorporated herein by reference.

### BACKGROUND OF THE INVENTION

(a) Field of the Invention

The present invention relates to an electron gun for a cathode ray tube, and more particularly to, an electron gun for a cathode ray tube, in which it is possible to optimize the diameter of an electron beam-passing means provided to an electrode focusing electrons emitted from a cathode.

(b) Description of the Related Art

A conventional electron gun formed at a color cathode ray tube, which includes three cathodes emitting electrons, a plurality of grid fixedly mounted in a line by a pair of bead glasses and respectively having three electron beam-passing holes opposite to the cathodes.

As shown in FIG. 1, each cathode include a cylindrical sleeve 102 supported by a holder (not shown), a base metal 104 supported by the sleeve 102 and applied with an electron emitting materials 106 on a top surface thereof, and a heater 108 installed in the inside of the sleeve 102.

Accordingly, if the base metal 104 is heated by the heater 108, electrons which through an electron beam-passing hole 110 passes are focused by the first grid 112 performing focusing operation as shown in dotted lines of FIG. 1, and preliminarily focused by a preliminary focus lens (not shown) which is formed between the second grid (not shown) and the third grid (not shown) while being diffused by the second grid (not shown).

Then, the electrons are focused and accelerated by a main focus lens (not shown) formed between the third grid (not shown) which is a focusing electrode and the fourth grid (not shown) which is an accelerating electrode, so that the electrons are formed as electron beams and collide with fluorescent materials of the screen by being led by a high voltage applied to the fourth grid (not shown) and an inside surface of a panel (not shown).

In the electron gun constructed as above, a focusing ratio of the electron beams should be improved to increase the resolution of the cathode ray tube and the diameter of the electron beam-passing hole of the first grid should be optimized, that is, the diameter should be reduced below a predetermined level to improve the focusing ratio.

According to related art, there is a limit to optimize the diameter of the electron beam-passing hole 110 provided in the first grid 112. Generally, brightness is improved in proportion to the quantity of the electrons, which pass through the electron beam-passing holes 110.

However, in the prior art cathode in which the base metal is formed evenly, if the diameter of the electron beam-passing hole is reduced, the density of the electron beams focused while passing through the electron beam-passing hole 110, is reduced accordingly. Consequently, it brings about a contrary effect that the electron emitting area B is reduced. In order to prevent this contrary effect, a current density should be increased, and in such case, there is a problem that the lifespan of the cathode is decreased.

### SUMMARY OF THE INVENTION

Therefore, the present invention is designed to resolve the above disadvantages and problems of the related art and has an object to provide an electron gun for a cathode ray tube in which it is possible to optimize the diameter of an electron beam-passing hole provided to an electrode for focusing electrons emitted from a cathode.

In order to achieve the above and further objects of the present invention, an electron gun for a cathode ray tube includes a plurality of cathodes having electron emitting materials, a plurality of grids arranged at one side of the cathodes in sequence, each grid having a plurality of electron beam-passing holes corresponding to the cathodes, and a shield cup connected to a grid distant-most the cathode and having a plurality of holes corresponding to the cathodes. Each cathode includes a cylindrical sleeve, a base metal supported by the sleeve, and a heater installed in the inside of the sleeve for heating the base metal. The base metal has a concave surface applied with electron emitting materials, and has a uniform radius of a curvature from a central point in the electron beam-passing hole of a first grid that is closest to the cathode, wherein the central point is located flush with a surface of the first grid toward the cathode.

In the electron gun of the present invention, the electron gun has three cathodes, and each grid has three beam-passing holes.

With the electron gun for a color cathode ray tube of the present invention constructed as above, it is possible to improve the electron focusing ratio of a first grid, since the surface applied with the electron emitting materials is concavely formed at an equal curvature from the center point in the electron beam-passing hole of a first grid which is a focusing electrode.

Accordingly, even if the diameter of the electron beam-passing hole that provided to the first grid is reduced, it is possible to increase the quantity of electrons passing through the electron beam-passing holes without increasing the current density.

### BRIEF DESCRIPTION OF THE DRAWINGS

The accompanying drawings provide a further understanding of the invention and, together with the Detailed Description, explain the principles of the invention. In the drawings:

FIG. 1 is a schematic view showing a conventional cathode of an electron gun for a cathode ray tube;

FIG. 2 is a cross section showing an electron gun for a cathode ray tube according to the present invention; and

FIG. 3 is a schematic view showing a cathode of an electron gun for a cathode ray tube according to the present invention.

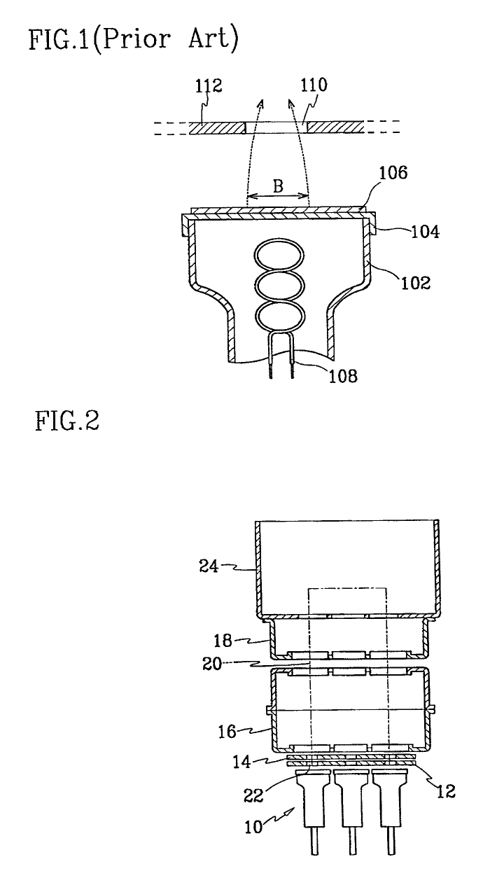

### DETAILED DESCRIPTION OF THE PREFERRED EMBODIMENTS

The present invention will be explained in more detail with reference to a preferred embodiment in junctions with the accompanying drawings.

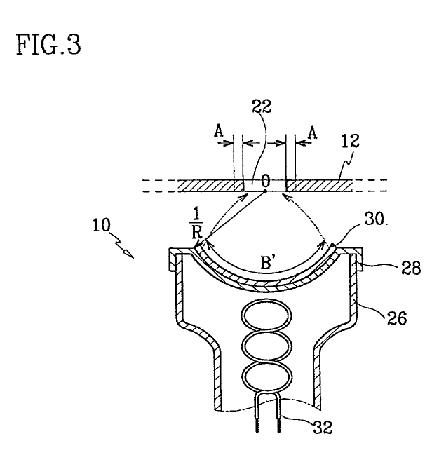

As shown in FIG. 2, and FIG. 3, an electron gun formed at a color cathode ray tube (not shown) include three cathodes 10 emitting electrons, a plurality of grid 12,14,16,18 fixedly mounted in a line by a pair of bead glasses 20 and respectively having three electron beam-passing holes 22 opposite to the cathodes 10, and a shield cup 24 connected with a grid 18 distant-most the cathodes 10 and having three electron beam-passing holes.

Each cathode 10 include a cylindrical sleeve 26 supported by a holder (not shown), a base metal 28 supported by the sleeve 26 and applied with an electron emitting materials 30 on a top surface thereof, and a heater 32 installed in the inside of the sleeve 26.

Herein, each electron beam-passing hole of a first grid 12 has a diameter which is smaller than that of a related art by a predetermined degree(2A). And the base metal 28 has a concave upper surface.

The concave upper surface is applied with the electron emitting materials 30, wherein the surface is formed at an equal radius of the curvature 1/R from a center O of each electron beam-passing hole 22 of the first grid 12, wherein the central point is located flush with a surface of the first grid 12 toward the cathode 10, and the radius of the curvature 1/R of the base metal 28 is preferably 110˜125 μm.

Therefore, in the electron gun according to the present invention, an area that emits the electrons focused by the first grid has an expanded area B′ in comparison with a corresponding area B of the related art.

Now, the operation of the electron gun will be explained in more detail with reference to FIG. 2 and FIG. 3.

As the base metal 28 is heated by the heater 32, electrons are focused by the first grid 12 as shown in dotted lines, and preliminarily focused by a preliminary focus lens (not shown), which is formed between the second grid 14 and the third grid 16, while being diffused by the second grid 14.

Then, the electrons are focused and accelerated by a main focus lens (not shown) formed between the third grid 16 which is a focusing electrode and the fourth grid 18 which is an accelerating electrode, so that the electrons are formed as electron beams and collide with fluorescent materials of screen by being led by a high voltage applied to the fourth grid 18 and the inside surface of a panel.

As above, according to the electron gun for a cathode ray tube according to the present invention, it is possible to focus the electrons equal to or more than that of the related art without increasing the current density even if the diameter of the electron beam-passing hole of the first grid is reduced. Therefore, it is possible to improve the electron focusing ratio of the first grid while preventing the decrease of the lifespan, thereby improving the resolution of the cathode ray tube.

Likewise, in case that the diameter of the electron beam-passing hole of the first grid is set equal to that of the related art, it is possible to improve the brightness since the quantity of the focused electrons is increased by the current equal to that of the related art.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. An electron gun for a cathode ray tube comprising:
a plurality of cathodes having electron emitting materials;
a plurality of grids arranged at one side of the cathodes in sequence, each grid having a plurality of electron beam-passing holes corresponding to the cathodes; and
a shield cup connected with a grid distant-most the cathode and having a plurality of electron beam-passing holes corresponding to the cathodes;
wherein the cathode comprises a cylindrical sleeve, a base metal supported by the sleeve and having a concave surface applied with the electron emitting materials with a uniform radius of a curvature from a central point in the electron beam-passing hole of a first grid that is closest to the cathode, and a heater installed in the inside of the sleeve for heating the base metal.

2. The electron gun for a cathode ray tube of claim 1, wherein the electron gun has three cathodes.

3. The electron gun for a cathode ray tube of claim 2, wherein each grid has three holes.

4. The electron gun for a cathode ray tube of claim 1, wherein the radius of the curvature of the base metal is 110˜125 μm.
